(19) United States
(12) Patent Application Publication
(10) Pub. No.: US 2007/0126278 A1
(43) Pub. Date: Jun. 7, 2007

(54) Wheel balance weight for automobile tire

(75) Inventor: Pal Sung Baek, Gyeonggi-do (KR)

Correspondence Address: OSHA LIANG L.L.P., 1221 MCKINNEY STREET, SUITE 2800, HOUSTON, TX, 77010, US

(73) Assignee: DONGHWA TECH CO. (Korean Corp), Incheon (KR)

(21) Appl. No.: 11/635,427

(22) Filed: Dec. 7, 2006

(30) Foreign Application Priority Data
Dec. 7, 2005 (KR) 10-2005-0118883

(51) Int. Cl. B60B 1/00

(52) U.S. Cl. 301/5.21

(57) ABSTRACT

Disclosed is a balance weight installed at a wheel for an automobile tire. The balance weight is provided with a “C” shaped hooking element forcibly fitted and coupled to an appropriate position on the rim flange of the wheel, thus making its installation state more stable, and providing enhanced durability and reliability.

### BACKGROUND OF INVENTION

1. Field of the Invention

The present invention relates to a clip type balance weight installed at a wheel for an automobile tire, and more particularly, to a wheel balance weight for an automobile tire which makes its installation state more stable and provides enhanced durability.

2. Background Art

An automobile tire is manufactured by a vulcanization process using a predetermined mold. In the process of forming the tire, it is likely to be out of weight balance of the tire, i.e., there inevitably occurs irregular distribution of the tire weight. Such imbalance of the tire weight causes chassis vibrations during its rotation to decrease vehicle ride comfort. Moreover, when the vibration is too excessive or continuously generated for an extended period of time, fatigue is continuously applied to the chassis and at the same time gaps occur between various parts to reduce lifespan and steering stability of the automobile, thereby increasing the risk of being involved in a car accident.

In order to solve the above problems, a balance weight having an appropriate weight is installed at a symmetrical point where imbalance of the tire is compensated to uniformly maintain weight distribution of the tire.

More specifically, an automobile tire is installed around a wheel coupled with an axle and filled with the air in a tubeless shape. At this time, a balance weight may be installed at an appropriate position of an inner rim of the wheel upon which the tire is mounted, to thereby compensate imbalance of the tire weight.

This balance weight is generally formed of lead having a relatively large specific gravity. However, such a balance weight formed of lead may cause environmental contamination problems. For this reason, the balance weight distributed in recent years is manufactured by using soft steel and so on.

In the above process, the conventional balance weight is mainly mounted in a clip or adhesive manner using a double-sided tape. For example, in case of using a clip-on type balance weight, the balance weight is forcibly clipped on an appropriate position of the rim flange of a wheel. Specifically, the clip-on type balance weight is formed of a hooking element that has a “C” shaped lateral section to be forcibly clipped on the rim of a wheel by using its own elasticity, and a weight element attached to a lower portion of the hooking element for counterbalancing the weight of the tire. In this structure, the weight element may be riveted or gripped on the hooking element.

However, when the weight element and the hooking element are riveted together, the number of processes required increases and bonding between them is not stable enough. In addition, defects frequently occur during the riveting process and the weight element sometimes separates from the hooking element during usage. As a result, all of these contribute to poor reliability of the product.

On the other hand, when the weight element is gripped on the hooking element, the lower portion of the hooking element is extended to a certain length and its end portion is curved in an arc tube shape through a predetermined bending process to form a gripping element. This gripping element grips the weight element provided in a bar shape of a predetermined length. At this time, if gripping of the weight element is not stable, that is, if the bar shaped weight element is gripped in its Y-axis direction by the gripping element while fatigue is continuously applied to its X-axis direction (the axis length direction) alone, the gripping section is slackened and the weight element moves in the X-axis direction. In worst case, the weight element is separated from the gripping element.

Further, the hooking element is stuck to the rim of the wheel by its elastic force, namely, a restoring force originated from the “C” shaped hooking element itself. This hooking element is forcibly fitted along the rim flange of a predetermined arc shape to a position passing the vertex and remains in that state by its elastic restoring force.

Unfortunately, however, such a hooking element is easily separated by an external force. In other words, as the hooking element is held simply by its elastic restoring force, the hooking element slides off along the rim flange passing the vertex when an external force greater than the restoring force is applied, thereby deteriorating durability and reliability, and rendering its installation state unstable.

### SUMMARY OF INVENTION

Therefore, the present invention has been made in view of the above problems of the prior arts, and it is a primary object of the present invention to provide a wheel balance weight for an automobile tire, in which a weight element of the balance weight and a gripping element on which the weight element is gripped are securely coupled to each other by female and male coupling structures, to thereby enhance durability and reliability of the product.

Another object of the present invention is to provide a wheel balance weight for an automobile tire, in which an inhibiting piece is installed at each of the hooking element and the gripping element of the balance weight to prevent components built in the hooking element or the gripping element from separating in the reverse direction of the assembly, to thereby make its installation state more stable and strong, and provide an enhanced durability.

According to the present invention to accomplish the above objects, there is provided a clip type balance weight installed at a wheel for an automobile tire, the balance weight comprising a “C” shaped hooking element forcibly fitted and coupled to an appropriate position on the rim flange of the wheel, and a gripping element for gripping a bar shape weight element for counterbalancing the weight of the tire, the gripping element being formed by extending a lower portion of the hooking element to a predetermined length and curving the end portion thereof in an arc shape through a predetermined bending process, wherein the balance weight further comprises male and female coupling elements provided in each of the gripping element and the weight element in an interconnected structure to prevent the weight element from moving freely or separating from the gripping element slackened due to fatigue, thereby making its installation state more stable, and providing enhanced durability and reliability.

The other objectives and advantages of the invention will be understood by the following description and will also be appreciated by the embodiments of the invention more clearly. Further, the objectives and advantages of the invention will readily be seen that they can be realized by the means and its combination specified in the claims.

### BRIEF DESCRIPTION OF DRAWINGS

FIGS. 1 and 2 show details of a wheel balance weight for an automobile tire according to the present invention;

FIG. 3 is a view for explaining the inhibiting piece arranged on both ends of the hooking element;

FIG. 4 is a view for explaining the inhibiting pieces arranged in each split gripping segment; and

FIG. 5 shows a wheel balance weight for an automobile tire according to another embodiment of the present invention, in which the inhibiting pieces of the hooking element are formed by punching a part of the main wall of the hooking element like arrowheads.

### DETAILED DESCRIPTION

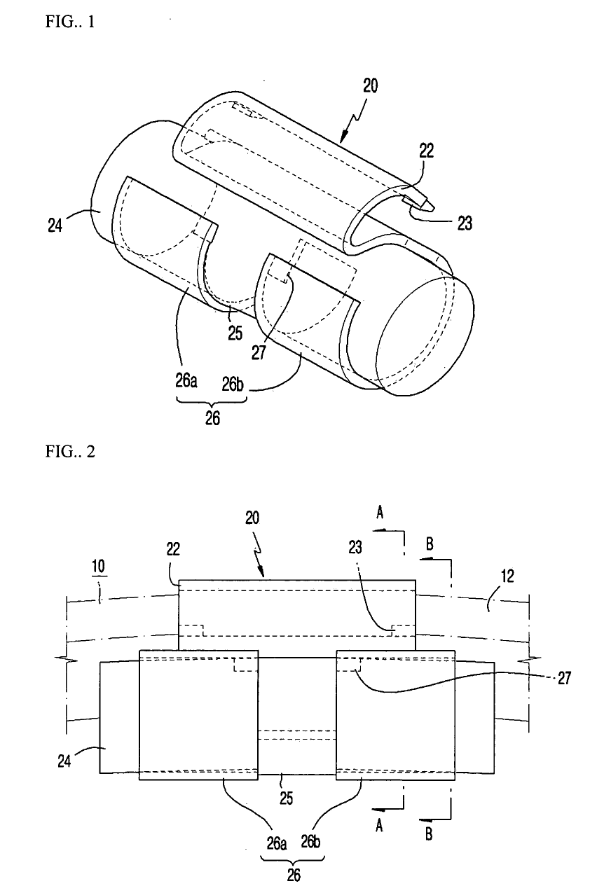

Hereinafter, a preferred embodiment of the present invention will be described in more detail with reference to the accompanying drawings. FIGS. 1 and 2 show details of a wheel balance weight for an automobile tire according to the present invention.

The present invention provides a balance weight 20 clipped on a rim 12 of a wheel 10 for an automobile tire for compensating imbalance of weight distribution of the automobile tire, wherein the balance weight 20 includes a “C” shaped hooking element 22 that is forcibly fitted and coupled by its elastic force to an appropriate position on the rim 12 flange of the wheel 10; and a tube shape gripping element 26 for gripping a bar shape weight element 24 for counterbalancing the weight of the tire, the gripping element being formed by extending a lower portion of the hooking element 22 to a predetermined length and curving the end portion thereof in an arc shape through a predetermined bending process. Here, the weight element 24 has a slightly longer length than the total horizontal length of the gripping element 26.

The most essential technique of the present invention is to introduce male and female coupling elements provided in each of the weight element 24 and the gripping element 26 in an interconnected structure to prevent the weight element 24 from moving freely or separating from the gripping element 26 slackened due to fatigue, to be more specific, to prevent the weight element 24 gripped on the gripping element 26 from separating or moving along the X-axis direction inside the gripping element 26.

The interconnected structure of male and female coupling elements solves its technical problem by improving the shape of each of the weight element 24 and the gripping elements 26 gripped in a direction intersecting from the outside of the weight element 24.

For example, the gripping element 26 may be divided into two in its longitudinal direction, so that two split gripping segments 26a and 26b are formed on both sides to be able to act as female grapping means in a space therebetween. In addition, the main wall surface of the weight element 24 has at least one coupling protrusion 25 with a larger outer diameter than the inner diameter of the split gripping segments 26a and 26b. The protrusion 25 is protruded through the space between the split gripping segments 26a and 26b to enable the weight element 24 to be connected between the split gripping segments 26a and 26b in a chin-up manner. In this manner, the weight element 24 is coupled in the X-axis direction inside the gripping element 26. Optionally, the coupling protrusion 25 may be arranged at both end portions of the weight element 24.

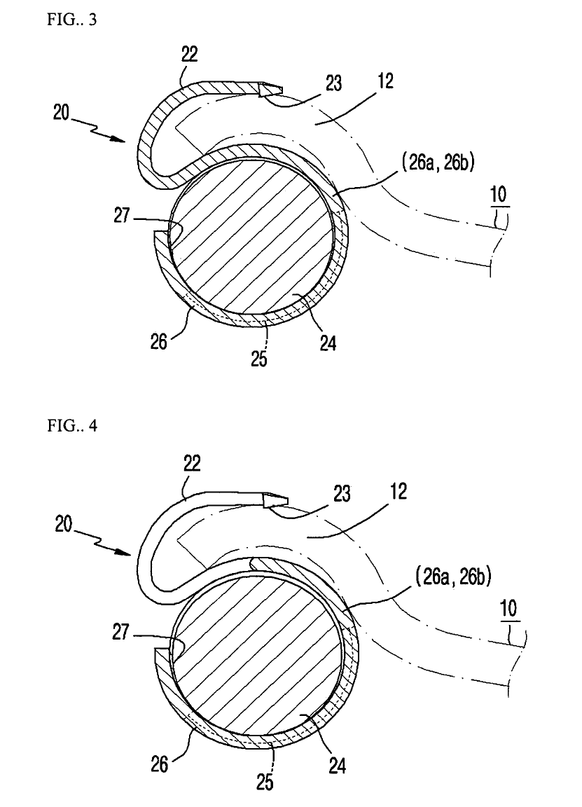

Furthermore, the hooking element 22 includes on its both ends inhibiting pieces 23 as shown in FIG. 3. The inhibiting pieces 23 prevent the hooking element 22 from separating from the rim 12 of the wheel 10 in the reverse direction of the assembly. More specifically, even though an external force greater than the restoring force of the hooking element 22 is applied thereto, the inhibiting pieces 23 whose sharp end portion has an inhibiting force in the reverse direction of the assembly on the arc surface of the rim 12 resist such an external force on the both end portions of the hooking element 22. These inhibiting pieces 23 can be molded by performing a predetermined press plastic process on both sides of the hooking element 22.

Moreover, as shown in FIG. 4, inhibiting pieces 27 are also provided in each of the split gripping segments 26a and 26b in order to prevent the gripped weight element 24 from moving in the reverse direction of the assembly. These inhibiting pieces can also be molded through the predetermined press plastic process as discussed above.

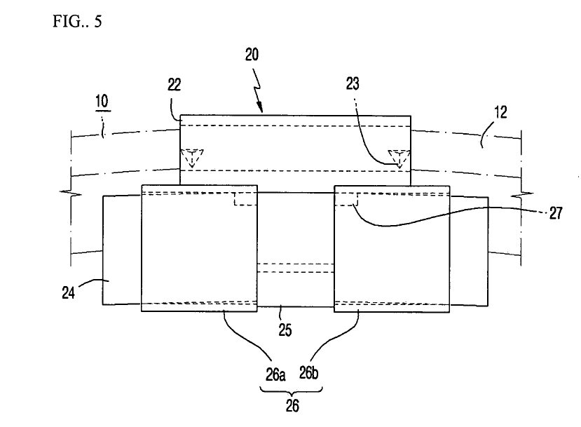

FIG. 5 illustrates another embodiment of the present invention. In this embodiment, the inhibiting pieces 23 of the hooking element 22 is formed by punching a part of the main wall of the hooking element 22 like arrowheads through a different press plastic process.

In conclusion, the wheel balance weight for an automobile tire according to the present invention can make its installation state more stable and strong, and enhance the reliability of the product by securely coupling the weight element of the balance weight and the gripping element on which the weight element is gripped to each other through the female and male coupling structures.

In addition, the present invention is provided with the inhibiting piece in each of the hooking element and the gripping element of the balance weight to prevent components built in the hooking element or the gripping element from separating in the reverse direction of the assembly, thereby improving durability of the product.

While the present invention has been shown and described with respect to particular embodiments, it will be apparent to those skilled in the art that many changes and modifications may be made without departing from the spirit and scope of the invention as defined in the appended claims.

What is claimed is:

1. A wheel balance weight for an automobile tire, comprising:
a “C” shaped hooking element forcibly fitted and coupled to an appropriate position on the rim flange of a wheel for an automobile tire;
a gripping element for gripping a bar shape weight element for counterbalancing the weight of the tire, the gripping element being formed by extending a lower portion of the hooking element to a predetermined length and curving the end portion thereof in an arc shape through a predetermined bending process;
male and female coupling elements provided in each of the gripping element and the weight element in an interconnected structure to prevent the weight element from moving freely or separating from the gripping element slackened due to fatigue.

2. A wheel balance weight for an automobile tire, comprising:
a “C” shaped hooking element forcibly fitted and coupled to an appropriate position on the rim flange of the wheel;
a gripping element for gripping a bar shape weight element for counterbalancing the weight of the tire, the gripping element being formed by extending a lower portion of the hooking element to a predetermined length and curving the end portion thereof in an arc shape through a predetermined bending process;
split gripping segments formed on both sides by dividing the gripping element in a longitudinal direction; and
at least one coupling protrusion with a larger outer diameter than the inner diameter of the split gripping segments on the main wall surface of the weight element, and partially protruded to connect the weight element and the split gripping segments in a chin-up manner.

3. The wheel balance weight according to claim 2, further comprising an inhibiting piece provided in the hooking element to prevent the hooking element from separating in the reverse direction of the assembly from the rim of the wheel.

4. The wheel balance weight according to claim 2, further comprising inhibiting pieces provided in each of the split gripping segments to prevent the weight element gripped on each of the split gripping elements from separating in the reverse direction of the assembly.

5. A wheel balance weight for an automobile tire, comprising:
a “C” shaped hooking element forcibly fitted and coupled to an appropriate position on the rim flange of a wheel of the automobile tire;
a gripping element for gripping a bar shape weight element for counterbalancing the weight of the tire, the gripping element being formed by extending a lower portion of the hooking element to a predetermined length and curving the end portion thereof in an arc shape through a predetermined bending process;
split gripping segments formed on both sides by dividing the gripping element in a longitudinal direction;
at least one coupling protrusion with a larger outer diameter than the inner diameter of the split gripping segments on the main wall surface of the weight element, and partially protruded to connect the weight element and the split gripping segments in a chin-up manner; and
an inhibiting piece provided in the hooking element to prevent the hooking element from separating in the reverse direction of the assembly from the rim of the wheel.

6. The wheel balance weight according to claim 5, further comprising an inhibiting piece provided in each of the split gripping segments to prevent the weight element gripped on each of the split gripping segments from separating in the reverse direction of the assembly.
